(19) United States
(12) Patent Application Publication
(10) Pub. No.: US 2018/0074627 A1
(43) Pub. Date: Mar. 15, 2018

(54) ELECTRONIC DEVICE INCLUDING DISPLAY EMITTING LIGHT TO PROVIDE OPTICS-BASED FINGERPRINT DETECTION

(71) Applicant: Samsung Electronics Co., Ltd., Suwon-si (KR)

(72) Inventors: Kiho KONG, Suwon-si (KR); Kwanhee Lee, Seoul (KR)

(73) Assignee: Samsung Electronics Co., Ltd., Suwon-si (KR)

(21) Appl. No.: 15/677,599

(22) Filed: Aug. 15, 2017

(30) Foreign Application Priority Data
Sep. 13, 2016 (KR) 10-2016-0117902
Mar. 2, 2017 (KR) 10-2017-0027213

(51) Int. Cl. G06F 3/041; G06K 9/00; G06F 21/32

(52) U.S. Cl. CPC G06F 3/0412; G06F 3/0416; G06F 21/32; G06K 9/00013

(57) ABSTRACT

An electronic device includes a display panel and an image sensor. The image sensor is disposed under the display panel to spatially correspond to a location of a partial area on the display panel. In response to a request occurring while the display panel is not driven or is in a stand-by mode, the display panel emits light having brightness equal to or higher than a reference brightness through pixels spatially corresponding to a location at which the image sensor is disposed. The image sensor outputs an image signal associated with an object on the partial area, based on the emitted light.

### CROSS-REFERENCE TO RELATED APPLICATIONS

The present application claims priority under 35 U.S.C. § 119 to Korean Patent Application Nos. 10-2016-0117902 filed on Sep. 13, 2016, and 10-2017-0027213 filed on Mar. 2, 2017, in Korean Intellectual Property Office, the entire contents of each of which are incorporated herein by reference.

### TECHNICAL FIELD

The present disclosure relates to an electronic device, and more particularly, relates to operations and configurations of the electronic device for providing a function of fingerprint detection.

### DESCRIPTION OF THE RELATED ART

Nowadays, various kinds of electronic devices are being used. An electronic device provides its own function(s) according to operations of various electronic circuits/modules/chips included therein. A computer, a smart phone, a tablet, and the like, are some examples of electronic devices. Such electronic devices include many electronic circuits/modules/chips to provide various functions thereof.

An electronic device includes various input interface circuits/modules/chips to receive input(s) from a user. The electronic device includes various output interface circuits/modules/chips to provide output(s) to the user. The electronic device may interface with the user through the input/output interface circuits/modules/chips.

Meanwhile, some electronic devices perform a user authentication function to provide a service to an authenticated user. For example, a fingerprint detection and recognition technique is widely used to invest a specific user with authority to use an electronic device. If the fingerprint detection and recognition technique is employed, the electronic device collects and stores information associated with a fingerprint of the user. In addition, the electronic device provides a service only to a user who is uniquely authenticated based on the stored fingerprint information.

### SUMMARY

Some example embodiments of the present disclosure may provide configurations and operations of an electronic device which is capable of performing an optics-based fingerprint detection. In some example embodiments, an interface used to detect a fingerprint may share an area on the electronic device with a display panel.

In some example embodiments, the electronic device may include a display panel and an image sensor. The display panel may include pixels. The image sensor may be disposed under one surface of the display panel to spatially correspond to a location of a partial area on the display panel.

In some example embodiments, in response to a request occurring while the display panel is not driven or is in a stand-by mode, the display panel may emit light through pixels which spatially correspond to a location at which the image sensor is disposed. The image sensor may output an image signal associated with an object which is on the partial area, based on the emitted light. The request occurring may be a touch event.

In some example embodiments, the display panel may display a reference image on some or all portions of the partial area, in response to the request which occurs while the display panel is not driven or is in the stand-by mode. In addition, the display panel may emit light through the pixels which spatially correspond to the location at which the image sensor is disposed, in association with contact or proximity of the object on or to the partial area on which the reference image is displayed. The image sensor may output an image signal associated with the object, based on the emitted light.

In some example embodiments, the display panel may emit light having brightness which is equal to or higher than reference brightness, through the pixels which spatially correspond to the location at which the image sensor is disposed.

In some example embodiments, the display panel may emit light in accordance with a reference emission pattern, through the pixels which spatially correspond to the location at which the image sensor is disposed.

In some example embodiment, the electronic device may further include a processor which is configured to compare a fingerprint indicated by the image signal with information stored in a memory. The memory in the electronic device may be a non-volatile memory.

In some example embodiments, the electronic device may further include a touch sensor panel and a touch processor. The touch sensor panel may generate a sensing signal in response to the contact or proximity of the object. The touch processor may process an operation associated with the contact or proximity of object, based on the sensing signal.

In some example embodiments, the electronic device may further include a display driver. The display driver may partially drive the display panel such that the display panel displays the reference image on some or all portions of the partial area. In addition, the display driver may drive the display panel such that the display panel emits light through the pixels which spatially correspond to the location at which the image sensor is disposed, in association with displaying the reference image.

According to some example embodiments, an interface used for fingerprint detection may share an area on the electronic device with the display panel, and thus the interface may not require an additional area on the electronic device. Accordingly, a size of the electronic device may be reduced, and/or a spare area may be used for other purpose. In addition, a configuration and an operation for performing a fingerprint detection function may be simplified.

### BRIEF DESCRIPTION OF THE DRAWINGS

The above and other objects and features will become apparent from the following description with reference to the following figures, wherein like reference numerals refer to like parts throughout the various figures unless otherwise specified, and wherein:

FIG. 1 is a conceptual diagram illustrating an example implementation of an electronic device which performs a function of fingerprint detection according to some example embodiments;

FIG. 2 is a block diagram illustrating an example configuration of the electronic device of FIG. 1;

FIG. 3 is a conceptual diagram illustrating an example configuration of the electronic device of FIG. 1;

FIG. 4 is a conceptual diagram for describing an example configuration and an example operation of the electronic device of FIG. 1;

FIG. 5 is a conceptual diagram for more fully describing the example configuration and the example operation of FIG. 4;

FIG. 6 is a flowchart describing an example operation of the electronic device of FIG. 1;

FIG. 7 is a flowchart describing an example implementation of a request described with reference to FIG. 6;

FIGS. 8 and 9 are conceptual diagrams illustrating example processes of performing a function of fingerprint detection according to the example operation of FIG. 6;

FIG. 10 is a flowchart describing an example operation of the electronic device of FIG. 1;

FIGS. 11 and 12 are conceptual diagrams illustrating example processes of performing a function of fingerprint detection according to the example operation of FIG. 10;

FIGS. 13 to 15 are conceptual diagrams illustrating example methods of driving pixels included in a display panel of the electronic device of FIG. 1; and

FIG. 16 is a block diagram illustrating an example implementation of an electronic device which performs a function of fingerprint detection according to some example embodiments.

### DETAILED DESCRIPTION OF EXAMPLE EMBODIMENTS

Below, some example embodiments will be described in detail and clearly to such an extent that those skilled in the art easily implement the present disclosure.

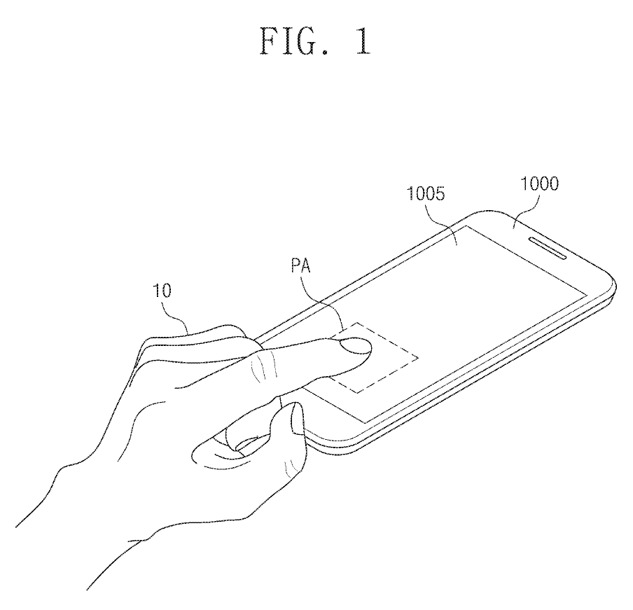

FIG. 1 is a conceptual diagram illustrating an example implementation of an electronic device which performs a function of fingerprint detection according to some example embodiments. In some example embodiments, an electronic device 1000 may be implemented with a mobile electronic device such as a smart phone, a tablet computer, a wearable device, or the like.

The electronic device 1000 may include a panel 1005 to interface with a user. The user of the electronic device 1000 may view information output from the electronic device 1000 through the panel 1005. The user of the electronic device 1000 may input a signal to the electronic device 1000 through the panel 1005. To this end, for example, the panel 1005 may include a display panel for outputting visual information to the user, a touch sensor panel for sensing a touch input of the user, and/or the like. The display panel may be an organic light-emitting diode.

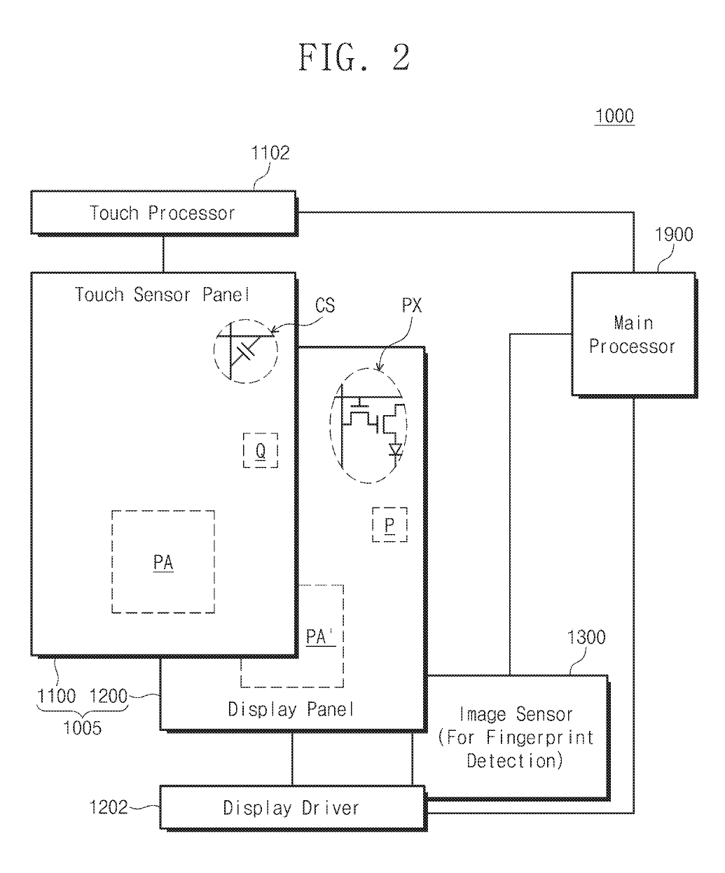

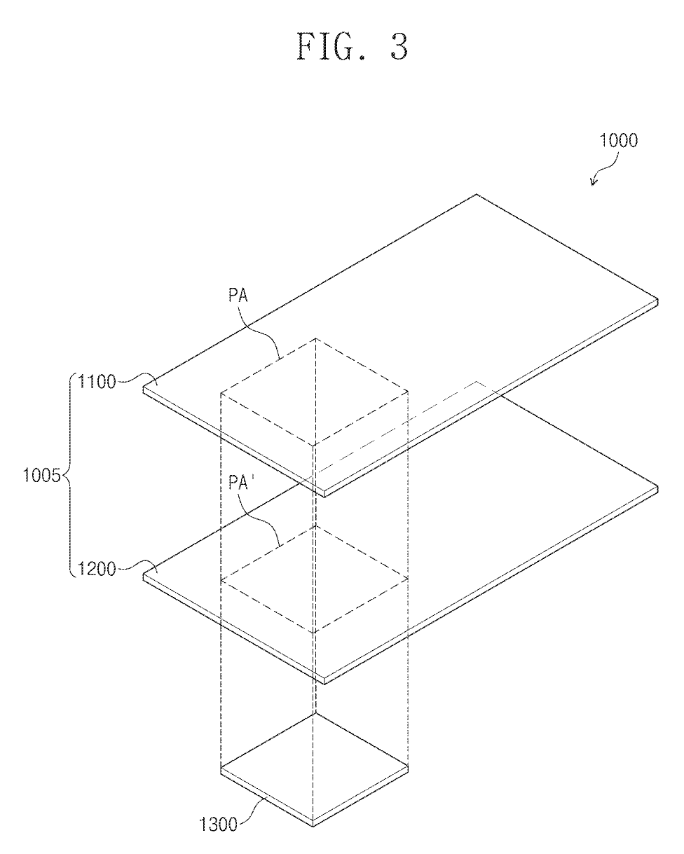

In some example embodiments, a partial area PA may be provided on the panel 1005. An image sensor for fingerprint detection may be disposed under the panel 1005, which will be described with reference to FIGS. 2 and 3. The image sensor for fingerprint detection may be disposed to spatially correspond to a location of the partial area PA.

The location of the partial area PA and arrangement of the image sensor may be variously modified or changed. FIG. 1 illustrates that the partial area PA is provided in a lower area on the panel 1005. However, in some example embodiments, the partial area PA may be provided in a middle or upper area on the panel 1005. The location and a size of the partial area PA may be changed depending on the arrangement of the image sensor. However, to facilitate better understanding, in the present disclosure, it will be described that the location of the partial area PA and the arrangement of the image sensor are associated with the lower area of the panel 1005.

The electronic device 1000 may perform a function of fingerprint detection to provide an authenticated user with a service. The electronic device 1000 may collect and store information associated with a fingerprint of the user. The electronic device 1000 may provide a service only to a user who is authenticated based on the stored fingerprint information. The electronic device 1000 may use an image sensor disposed under the panel 1005 to detect the fingerprint of the user.

The user of the electronic device 1000 may contact (or approach) the electronic device 1000 through an object 10. For example, the object 10 may include a finger of the user. The electronic device 1000 may recognize the object 10 in response to contact or proximity of the object 10 on or to the panel 1005.

For example, the finger of the user may contact or approach the partial area PA. The image sensor for fingerprint detection may be disposed to spatially correspond to the location of the partial area PA, and thus the image sensor may obtain an image associated with a fingerprint of a finger which contacts or approaches the partial area PA. The electronic device 1000 may determine, based on the obtained image, whether the fingerprint of the finger which contacts or approaches the partial area PA is a fingerprint of an authenticated user.

FIG. 2 is a block diagram illustrating an example configuration of the electronic device of FIG. 1. In some example embodiments, the electronic device 1000 may include the panel 1005 and an image sensor 1300. In some example embodiments, the panel 1005 may include a touch sensor panel 1100 and a display panel 1200.

The touch sensor panel 1100 may sense contact or proximity of an object (e.g., a finger of the user). For example, the touch sensor panel 1100 may generate a sensing signal, in response to the contact or proximity of the object. In some example embodiments, the touch sensor panel 1100 may include a plurality of sensing capacitors which are formed along rows and columns. FIG. 2 illustrates one example sensing capacitor CS. A capacitance value of the sensing capacitor CS may vary in response to the contact or proximity of the object.

In some example embodiments, the electronic device 1000 may further include a touch processor 1102 to control operations of the touch sensor panel 1100. The touch processor 1102 may process an operation associated with the contact or proximity of the object, based on the sensing signal output from the touch sensor panel 1100. For example, the touch processor 1102 may recognize the contact or proximity of the object, based on variation in the capacitance value of the sensing capacitor CS. For example, when the sensing signal is associated with execution or operation of a specific application, the touch processor 1102 may output a command to a main processor 1900 such that the specific application is to be executed or to operate. Touch processor 1102 may transmit wake up signal to the image sensor when contact of the object on the display panel is last than a reference time and the wake up signal converts a status of the image sensor from a low power mode into an active mode.

The display panel 1200 may output visual information for the user. The display panel 1200 may include a plurality of pixels which are arranged along rows and columns to display an image. FIG. 2 illustrates one example pixel PX. Each pixel may be configured to emit light of a specific color which forms the image. As the plurality of pixels emit light together, the display panel 1200 may display an intended image.

In some example embodiments, the electronic device 1000 may further include a display driver 1202 to control operations of the display panel 1200. The display driver 1202 may drive the display panel 1200. The display driver 1202 may suitably drive each pixel of the display panel 1200 in response to a command of the main processor 1900 such that the intended image is displayed.

Each coordinate on the touch sensor panel 1100 may be matched with each coordinate on the display panel 1200. For example, the display panel 1200 may display interface information on a specific area P. The user may contact or approach a specific area Q on the touch sensor panel 1100 to input a command through the displayed interface information. Herein, a coordinate of the specific area Q may be matched with a coordinate of the specific area P. Accordingly, contact or proximity on or to the specific area Q may be processed in association with the interface information displayed on the specific area P.

In some example embodiments, the touch sensor panel 1100 may be implemented separately from the display panel 1200. For example, as illustrated in FIG. 2, the touch sensor panel 1100 may be placed on or over the display panel 1200. For example, unlike that illustrated in FIG. 2, the display panel 1200 may be placed on or over the display panel 1100. On the other hand, in some example embodiments, the touch sensor panel 1100 and the display panel 1200 may be implemented in one single panel.

Example embodiments may be variously changed or modified without being limited to the example illustrated in FIG. 2. However, to facilitate better understanding, in the present disclosure, it will be described that the display panel 1200 is implemented separately from the touch sensor panel 1100 and is placed under or below the touch sensor panel 1100.

The image sensor 1300 may be used to detect a fingerprint. The image sensor 1300 may generate/output an image signal associated with the object which is on the partial area PA. For example, the image sensor 1300 may operate to obtain an image signal associated with a fingerprint of a finger which contacts or approaches the partial area PA.

The image sensor 1300 may provide a function of optics-based fingerprint detection. For example, the image sensor 1300 may generate/output an image signal (e.g., a signal for forming an image which indicates a fingerprint of a finger) associated with the object which is on the partial area PA, based on light emitted from the display panel 1200. To this end, the image sensor 1300 may include photo-diode(s) which is capable of generating current in response to light.

As described with reference to FIG. 1, the partial area PA may be provided on the panel 1005, for example, on the touch sensor panel 1100. In addition, a partial area PA′ may be provided on the display panel 1200 to correspond to the partial area PA. The image sensor 1300 may be disposed under the display panel 1200 to spatially correspond to a location of the partial areas PA and PA′.

Herein, the location of the partial area PA may be associated with coordinates on the touch sensor panel 1100, and the location of the partial area PA′ may be associated with coordinates on the display panel 1200. In addition, the location and a size of each of the partial areas PA and PA′ may be variously modified or changed depending on the arrangement of the image sensor 1300.

For example, the user of the electronic device 1000 may contact or approach the partial area PA (or the partial area PA′) through an object (e.g., a finger). In the touch sensor panel 1100, capacitance values of sensing capacitors which correspond to the partial area PA may vary in response to the contact or proximity of the finger. Accordingly, the touch processor 1102 may recognize the contact or proximity of the finger on or to the partial area PA, based on the varying capacitance values

The display driver 1202 may drive the display panel 1200 such that the pixels of the display panel 1200 emit light. In some example embodiments, the display driver 1202 may partially drive the display panel 1200 such that pixels corresponding to the partial area PA′ emit light.

The image sensor 1300 may generate/output an image signal (e.g., an image signal which is associated with a fingerprint) associated with an object (e.g., a finger) which is on the partial area PA, based on the light emitted from the pixels which correspond to the partial area PA′. The image signal may include information associated with the fingerprint. Accordingly, the electronic device 1000 may obtain the information associated with the fingerprint of the user. For example, the image signal may be provided to the main processor 1900.

In some example embodiments, the electronic device 1000 may further include the main processor 1900 to process overall operations of the electronic device 1000. The main processor 1900 may process/perform various arithmetic/logical operations to provide functions of the electronic device 1000.

For example, the main processor 1900 may include one or more special-purpose circuits (e.g., a field programmable gate array (FPGA), application specific integrated chips (ASICs), and/or the like) to perform various operations. For example, the main processor 1900 may include one or more processor cores which are capable of performing various operations. For example, the main processor 1900 may be implemented with a general-purpose processor, a special-purpose processor, or an application processor.

The main processor 1900 may communicate with the touch processor 1102, the display driver 1202, and the image sensor 1300. The main processor 1900 may control operations of the touch processor 1102, the display driver 1202, and the image sensor 1300. The main processor 1900 may process commands, requests, responses, and/or the like, which are associated with operations of the touch processor 1102, the display driver 1202, and the image sensor 1300.

For example, the main processor 1900 may process a command received from the touch processor 1102, to understand a user command input through the touch sensor panel 1100. For example, the main processor 1900 may provide a variety of information to the display driver 1202, to display an intended image on the display panel 1200.

For example, the main processor 1900 may control an operation timing/sequence of the display panel 1200 and the image sensor 1300 such that the image sensor 1300 generates the image signal associated with the fingerprint. For example, the main processor 1900 may generate image information associated with the fingerprint or may analyze the information associated with the fingerprint, based on the image signal output from the image sensor 1300. For example, the main processor 1900 may detect/determine whether a fingerprint indicated by the image signal is a fingerprint of an authenticated user.

However, the present disclosure is not limited to the above examples. Besides, the main processor 1900 may further perform and process various other operations to operate the electronic device 1000.

In some example embodiments, the touch sensor panel 1100, the touch processor 1102, the display panel 1200, the display driver 1202, the image sensor 1300, and the main processor 1900 may be respectively implemented with separate circuits/modules/chips. In some cases, on the basis of a function, some of the touch sensor panel 1100, the touch processor 1102, the display panel 1200, the display driver 1202, the image sensor 1300, and the main processor 1900 may be combined into one circuit/module/chip, or may be further separated into a plurality of circuits/modules/chips.

FIG. 3 is a conceptual diagram illustrating an example configuration of the electronic device of FIG. 1. As described with reference to FIGS. 1 and 2, the electronic device 1000 may include the panel 1005. For example, the panel 1005 may include the touch sensor panel 1100 and the display panel 1200. An area on the touch sensor panel 1100 may include the partial area PA, and an area on the display panel 1200 may include the partial area PA′. The location and the size of the partial area PA may correspond to the location and the size of the partial area PA′.

The display panel 1200 may include a first surface which faces the touch sensor panel 1100. The first surface of the display panel 1200 may display an image. The first surface of the display panel 1200 may include the partial area PA′. The display panel 1200 may further include a second surface opposite to the first surface.

The image sensor 1300 may be disposed under one surface of the display panel 1200. For example, the image sensor 1300 may be disposed under the second surface of the display panel 1200. As illustrated in FIG. 3, the image sensor 1300 may be disposed to spatially correspond to the location of the partial areas PA and PA′. Accordingly, the image sensor 1300 may generate/output the image signal associated with the object which contacts or approaches the partial area PA, and may operate based on light emitted from the pixels (of the display panel 1200) which correspond to the partial area PA′.

FIG. 4 is a conceptual diagram for describing an example configuration and an example operation of the electronic device of FIG. 1.

The user of the electronic device 1000 may contact or approach the partial area PA on the touch sensor panel 1100 through the object (e.g., a finger). The touch processor 1102 may recognize the contact or proximity of the object on or to the partial area PA, based on variations in capacitance values of sensing capacitors which correspond to the partial area PA.

When the touch processor 1102 recognizes the contact or proximity of the object on or to the partial area PA, the touch processor 1102 may output a control signal for driving the display driver 1202. In some example embodiments, the touch processor 1102 may provide the control signal directly to the display driver 1202. In some example embodiments, the control signal output from the touch processor 1102 may be indirectly provided to the display driver 1202 through other component(s) such as the main processor 1900 of FIG. 2.

The display driver 1202 may drive the display panel 1200 based on the control signal output from the touch processor 1102. The pixels included in the display panel 1200 may emit light under control of the display driver 1202.

In some example embodiments, the display driver 1202 may partially drive the display panel 1200, based on the control signal output from the touch processor 1102, such that the pixels corresponding to the partial area PA′ on the display panel 1200 emit light. That is, under control of the display driver 1202, the display panel 1200 may emit light through pixels which spatially correspond to a location at which the image sensor 1300 is disposed.

The light emitted from the display panel 1200 may be projected to the object 10 which is on the partial area PA. The projected light may be reflected from the object 10. The reflected light may be provided to the image sensor 1300, and the image sensor 1300 may generate/output an image signal based on the reflected light. Accordingly, the image sensor 1300 may output the image signal associated with the object 10 which is on the partial area PA, based on the light emitted from the display panel 1200. For example, when the object 10 is a finger, the image signal may include information associated with a shape of a fingerprint.

In some example embodiments, an optical element 1302 may be interposed between the display panel 1200 and the image sensor 1300. The optical element 1302 may be provided to suitably process the light reflected from the object 10. For example, the optical element 1302 may include a lens for adjusting a focus of light which is to be provided to the image sensor 1300. For example, the optical element 1302 may include a filter for adjusting a frequency characteristic or a polarization characteristic of light which is to be provided to the image sensor 1300. The present disclosure is not limited to the above examples, and the optical element 1302 may include other types of various optical elements.

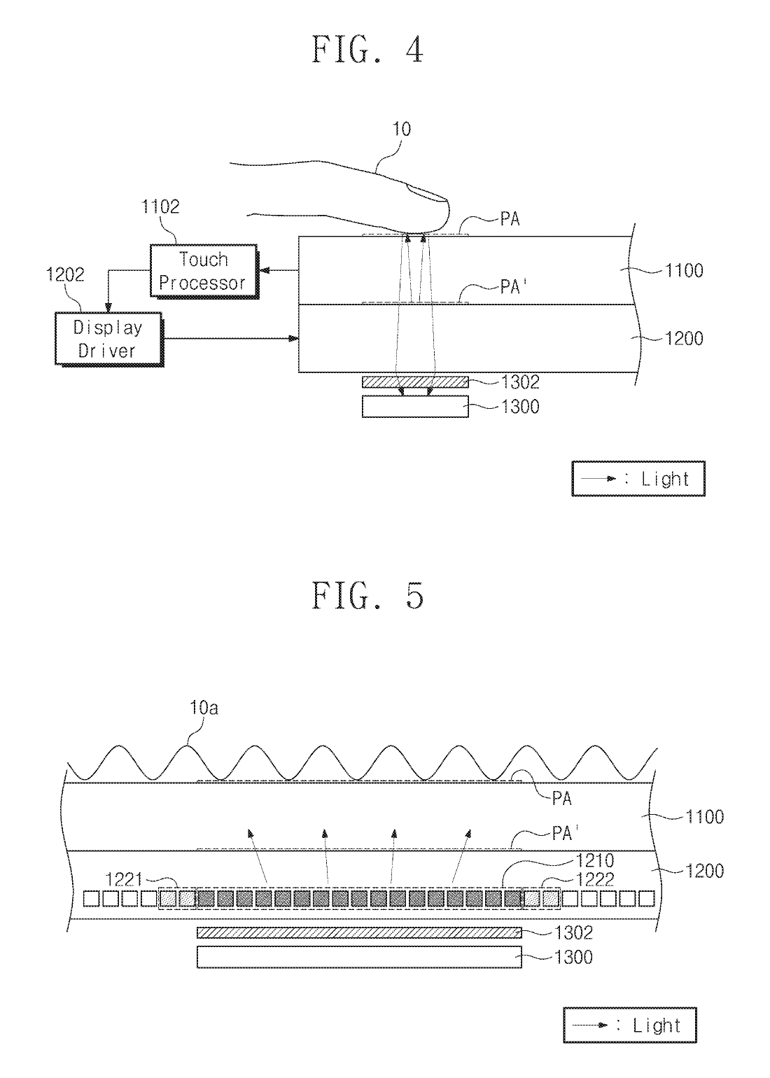

FIG. 5 is a conceptual diagram for more fully describing the example configuration and the example operation of FIG. 4.

As the object 10 contacts or approaches the partial area PA on the touch sensor panel 1100, a fingerprint 10a may contact or approach the partial area PA. When the contact or proximity is sensed, the display panel 1200 may emit light through pixels to generate an image signal associated with the fingerprint 10a. The emitted light may be reflected from the fingerprint 10a, and the image sensor 1300 may receive the reflected light to output the image signal. The image signal may be used to generate an image associated with the fingerprint 10a or to analyze information associated with the fingerprint 10a.

In some example embodiments, the display panel 1200 may emit light through pixels 1210 which correspond to the partial area PA′. In some cases, the light emitted from the pixels 1210 may be insufficient to obtain the image signal associated with the fingerprint 10a. In some example embodiments, the display panel 1200 may further emit light through neighboring pixels 1221 and 1222 beside the pixels 1210, together with the pixels 1210. In some cases, the light emitted from the pixels 1210, 1221, and 1222 may not be suitable to obtain the image signal associated with the fingerprint 10a due to interference of light. In some example embodiments, the display panel 1200 may be controlled such that some of the pixels 1210, 1221, and 1222 do not emit light.

That is, the display panel 1200 may emit light through pixels which spatially correspond to the location at which the image sensor 1300 is disposed. However, pixels which are selected to emit light may be variously changed or modified in order to be sufficient and suitable to obtain the image signal associated with the fingerprint 10a. The display panel 1200 may be partially driven, and pixels which are far away from the image sensor 1300 may not emit light. In some cases, the optical element 1302 may be provided to suitably adjust light which is to be provided to the image sensor 1300.

The present disclosure may provide an interface used to detect a fingerprint. For example, a function of fingerprint detection may be performed when the user contacts or approaches the touch sensor panel 1100 or the display panel 1200. According to the present disclosure, the interface and the image sensor 1300 used for fingerprint detection may share an area on the electronic device 1000 with the touch sensor panel 1100 and the display panel 1200, and thus the interface and the image sensor 1300 may not require an additional area on the electronic device 1000. Accordingly, it may be possible to reduce the size of the electronic device 1000, or a spare area may be used for other purpose(s).

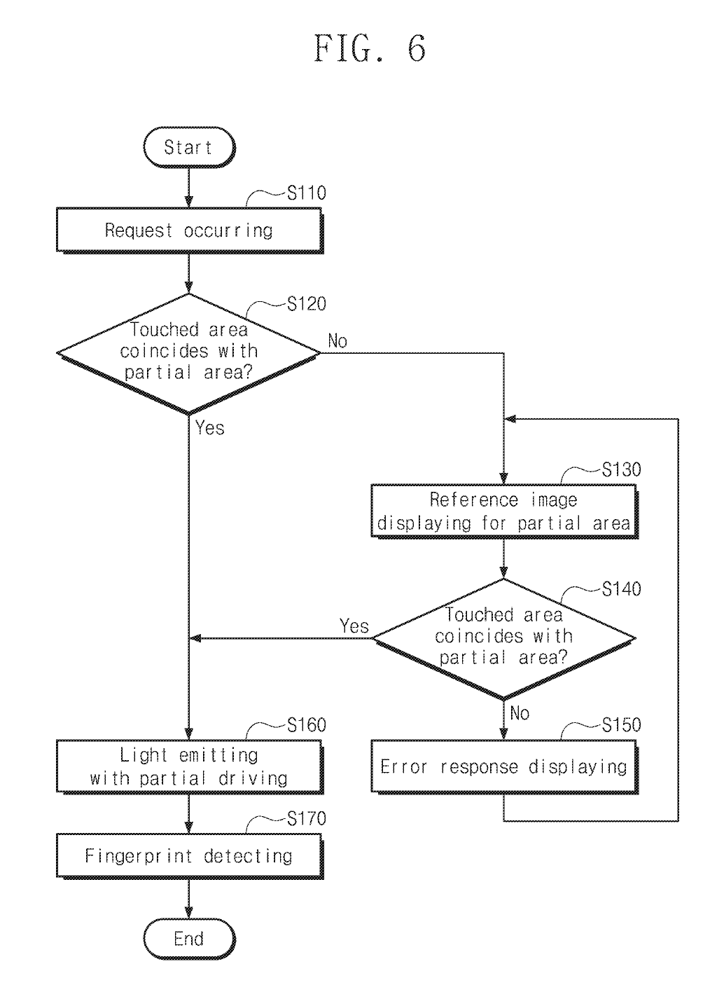

FIG. 6 is a flowchart describing an example operation of the electronic device of FIG. 1. To facilitate better understanding, FIG. 6 will be referenced together with FIGS. 1 and 2.

In operation S110, a request may occur. In the present disclosure, the “request” may be associated with a signal or an action which directs to detect a fingerprint. For example, the request may occur when any input is received from the user by the electronic device 1000, when a signal/command is generated in the electronic device 1000 based on the received input, and/or the like.

For example, the request may occur when the user contacts or approaches any area on the touch sensor panel 1100 or the display panel 1200 through the object 10 (i.e., the request may occur in response to a touch of the object 10). For example, the request may occur when the object 10 acts specific motion or gesture in the vicinity of the electronic device 1000. For example, the request may occur when the electronic device 1000 moves in a specific manner. The present disclosure is not limited to the above examples, and the request may be variously changed or modified to recognize directing of fingerprint detection.

For example, the request may occur while the electronic device 1000 is in an idle state or the display panel 1200 is not driven. For example, the request may occur while the display panel 1200 is in a stand-by mode. Herein, the stand-by mode may mean an operation mode where the display panel 1200 displays a reduced or the minimal amount of information (e.g., a current time, a date, and/or the like), and may be also called as an “Always ON display (AOD)” mode, an “active display mode”, and/or the like. For example, the request may occur while the display panel 1200 is in a normal mode. Herein, the normal mode may mean an operation mode where the display panel 1200 displays a variety of information according to intention of the user.

For example, the request of operation S110 may occur in response to contact or proximity of the object 10. In this case, in operation S120, the touch processor 1102 may determine whether a touched area coincides with the partial area PA (e.g., whether the touched area includes the partial area PA or is included in the partial area PA, or whether the touched area is substantially the same as the partial area PA). In such an example, the request may indicate whether the object 10 contacts or approaches the partial area PA or whether the object 10 contacts or approaches an area other than the partial area PA.

In the present specification, the contact or proximity on or to the partial area PA is described. However, since the location and the size of the partial area PA correspond to the location and size of the partial area PA′ on the display panel 1200, the contact or proximity on or to the partial area PA may also mean contact or proximity on or to the partial area PA′. This may be equivalently applied even when the display panel 1200 is placed on or over the touch sensor panel 1100.

When it is determined in operation S120 that the touched area does not coincide with the partial area PA, operation S130 may be performed. In operation S130, the display panel 1200 may display a reference image on the partial area PA′. Accordingly, when the request of operation S110 indicates that the object 10 contacts or approaches an area other than the partial area PA, the reference image may be displayed.

For example, the reference image may be displayed to inform the user of a location at which the image sensor 1300 is disposed. The image sensor 1300 may be disposed to spatially correspond to the location of the partial area PA′, and thus the user may recognize the location of the image sensor 1300 through the reference image. The display driver 1202 may partially drive the display panel 1200 such that the display panel 1200 displays the reference image on some or all portions of the partial area PA′.

For example, the reference image may include a figure which corresponds to an outline of an area at which the image sensor 1300 is disposed, and may be displayed on some portions of the partial area PA′. For example, the reference image may include a figure which is fully filled in an area at which the image sensor 1300 is disposed, and may be displayed on all portions of the partial area PA′. For example, the reference image may be further displayed on a peripheral area which somewhat deviates from the partial area PA′ such that it is sufficient to inform the user of an area at which the image sensor 1300 is disposed.

Afterwards, in response to displaying the reference image, the object 10 may again contact or approach any area on the touch sensor panel 1100 or the display panel 1200. Accordingly, in operation S140, the touch processor 1102 may determine whether the touched area coincides with the partial area PA in which the reference image is displayed.

In some cases, even though the reference image is displayed, the object 10 may again contact or approach an area other than the partial area PA and thus the touched area may not still coincide with the partial area PA. When it is determined in operation S140 that the touched area does not still coincide with the partial area PA, operation S150 may be performed. In operation S150, the display panel 1200 may display an error response. The error response may be displayed to inform the user that the touched area does not coincide with the partial area PA. In some cases, to inform the user of the location at which the image sensor 1300 is disposed, the display panel 1200 may again display the reference image in operation S130.

On the other hand, when it is determined in operation S120 or operation S140 that the touched area coincides with the partial area PA, operation S160 may be performed. In operation S160, the display panel 1200 may emit light through the pixels which spatially correspond to the location at which the image sensor 1300 is disposed. Accordingly, when the request of operation S110 indicates that the object 10 contacts or approaches the partial area PA, light may be emitted. Alternatively, when the object 10 contacts or approaches the partial area PA′ in which the reference image is displayed, light may be emitted.

To emit light in operation S160, the display driver 1202 may partially drive the display panel 1200. Emitting the light has been described with reference to FIGS. 4 and 5, and thus redundant descriptions will be omitted below for brevity.

In some example embodiments, in operation S160, pixels of the display panel 1200, which are selected to emit light, may emit light having brightness which is equal to or higher than reference brightness. Light of low brightness may be insufficient to detect a fingerprint. Accordingly, regardless of whether brightness indicated by a brightness setting value for the display panel 1200 is higher or lower than the reference brightness, the selected pixels of the display panel 1200 may emit light having brightness which is equal to or higher than the reference brightness in operation S160. The reference brightness may be suitably selected to be sufficient to detect a fingerprint precisely.

For example, even though the user sets the brightness of the display panel 1200 as first brightness which is lower than the reference brightness, the display panel 1200 may emit light having second brightness which is equal to or higher than the reference brightness in operation S160. For example, even though the user sets the brightness of the display panel 1200 as the first brightness, the second brightness of the light emitted in operation S160 may be brighter than the first brightness for displaying the reference image of operation S130.

In operation S170, the image sensor 1300 may output an image signal associated with the object 10 which is on the partial area PA, based on the light emitted in operation S160. The image signal may include information associated with the object 10 (e.g., information associated with a shape of a fingerprint). Accordingly, the electronic device 1000 may detect a fingerprint of the object 10 based on the image signal. For example, the main processor 1900 may detect whether the fingerprint indicated by the image signal is a fingerprint of an authenticated user. Accordingly, the electronic device 1000 may provide a service only to the authenticated user.

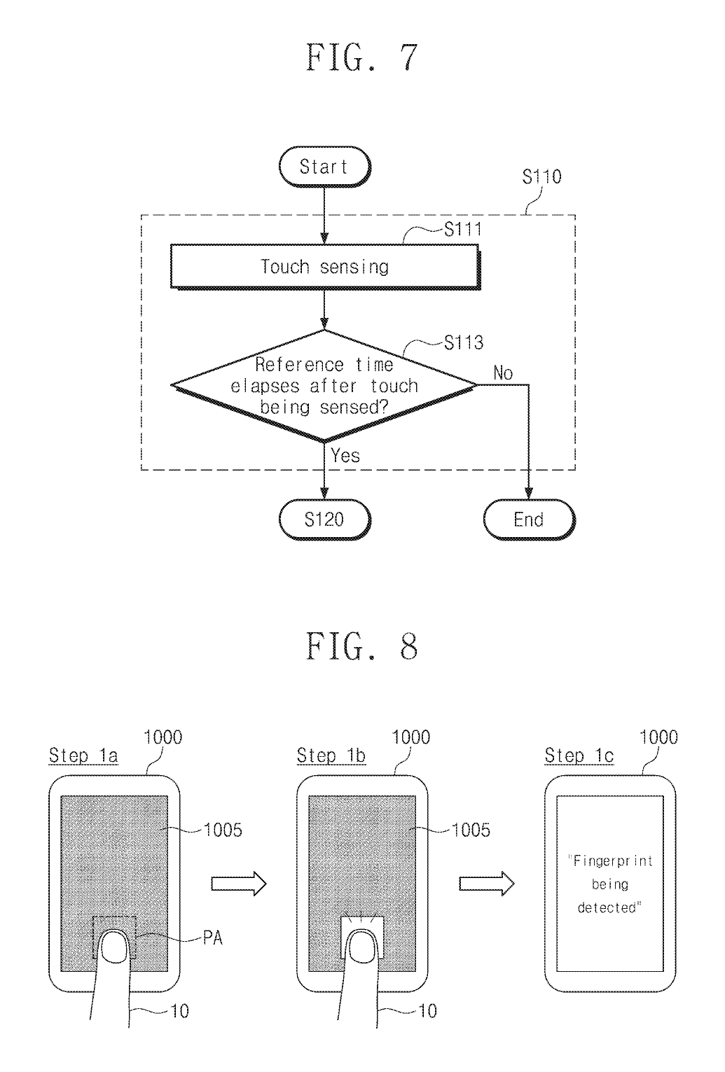

FIG. 7 is a flowchart describing an example implementation of the request described with reference to FIG. 6. To facilitate better understanding, FIG. 7 will be referenced together with FIGS. 1 and 2.

As described with reference to FIG. 6, the request may occur in operation S110. For example, the request of operation S110 may occur in response to the contact or proximity of the object 10 on or to the touch sensor panel 1100 or the display panel 1200 (i.e., the request may occur in response to a touch of the object 10). In such an example, operation S110 may include operation S111 and operation S113.

In operation S11, the touch processor 1102 may recognize the touch of the object 10, in response to variations in capacitance values of sensing capacitors included in the touch sensor panel 1100. In operation S113, the electronic device 1000 may determine whether a reference time elapses after the touch is sensed, under control of the touch processor 1102 and/or the main processor 1900.

When the reference time does not elapse after the touch is sensed (i.e., when the touch is not maintained during a time longer than the reference time), operation S110 of FIG. 7 may end. That is, when the object 10 contacts or approaches an area on the touch sensor panel 1100 or the display panel 1200 during a time shorter than the reference time, the electronic device 1000 may ignore the touch input. In addition, the display panel 1200 may not respond to the contact or proximity of the object 10.

For example, the user may contact the touch sensor panel 1100 by mistake while the electronic device 1000 is placed in a pocket or a bag. To reduce or prevent a response to a user mistake, the electronic device 1000 may ignore the touch input which occurs during a time shorter than the reference time.

On the other hand, a touch which is maintained during the reference time may mean that the user intends to perform a function of fingerprint detection. Accordingly, when it is determined in operation S113 that the reference time elapses after the touch is sensed, operation S120 of FIG. 6 may be performed. That is, the request of operation S110 may occur when the object 10 contacts or approaches any area on the touch sensor panel 1100 or the display panel 1200 during the reference time. The reference time may be selected to be suitable to understand the intention of the user.

However, FIG. 7 is provided to illustrate one of many possible example embodiments, and is not intended to limit the present disclosure. In some example embodiments, the reference time may not be considered, and the request of operation S110 may occur even in response to a touch of a short time length. In some example embodiments, the reference time may be considered with regard to other kinds of actions such as motion or gesture of the object 10, movement of the electronic device 1000, and/or the like. Example embodiments may be variously changed or modified to understand the intention of the user.

FIG. 8 is a conceptual diagram illustrating an example process of performing a function of fingerprint detection according to the example operation of FIG. 6. To facilitate better understanding, FIG. 8 will be referenced together with FIGS. 1 and 2.

In step 1a, a request may occur (refer to operation S110 of FIG. 6). For example, the request may occur in response to contact or proximity of the object 10 on or to any area on the panel 1005. For example, the request may occur while the display panel 1200 is not driven.

For example, the user may contact or approach the partial area PA through the object 10 by chance or on purpose. The electronic device 1000 may determine that a touched area coincides with the partial area PA (refer to operation S120 of FIG. 6). Accordingly, in step 1b, the electronic device 1000 may emit light by partially driving the display panel 1200 under control of the display driver 1202 (refer to operation S160 of FIG. 6). The electronic device 1000 may generate an image signal associated with the object 10 which is on the partial area PA, based on the emitted light.

Afterwards, in step 1c, the electronic device 1000 may detect a fingerprint based on the image signal (refer to operation S170 of FIG. 6). The electronic device 1000 may determine whether the detected fingerprint is a fingerprint of an authenticated user.

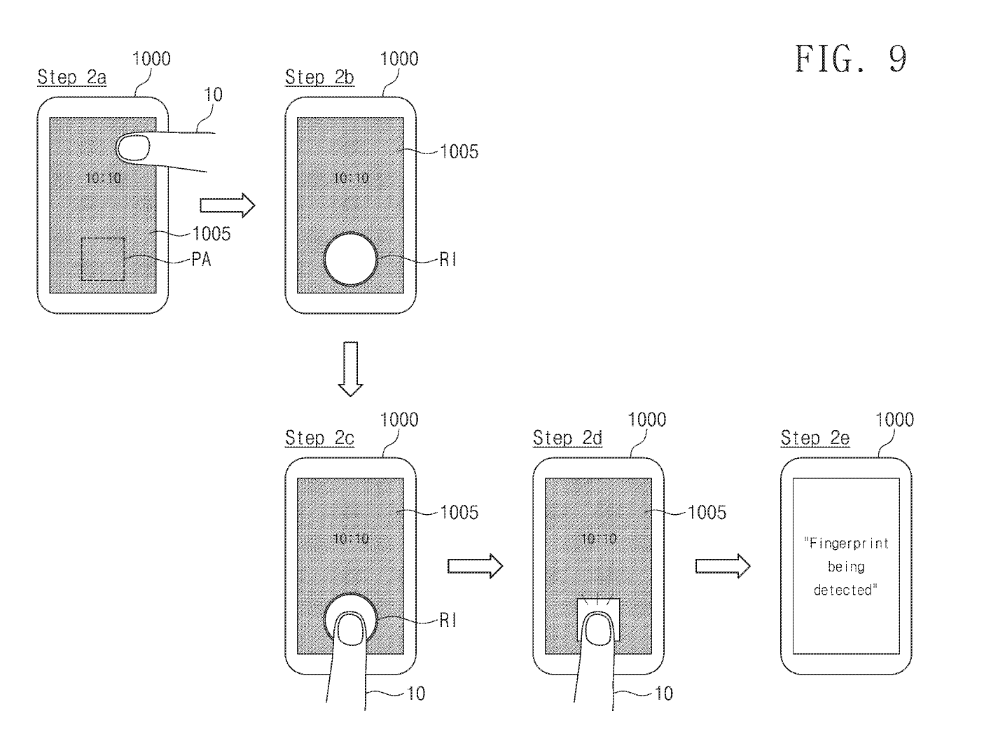

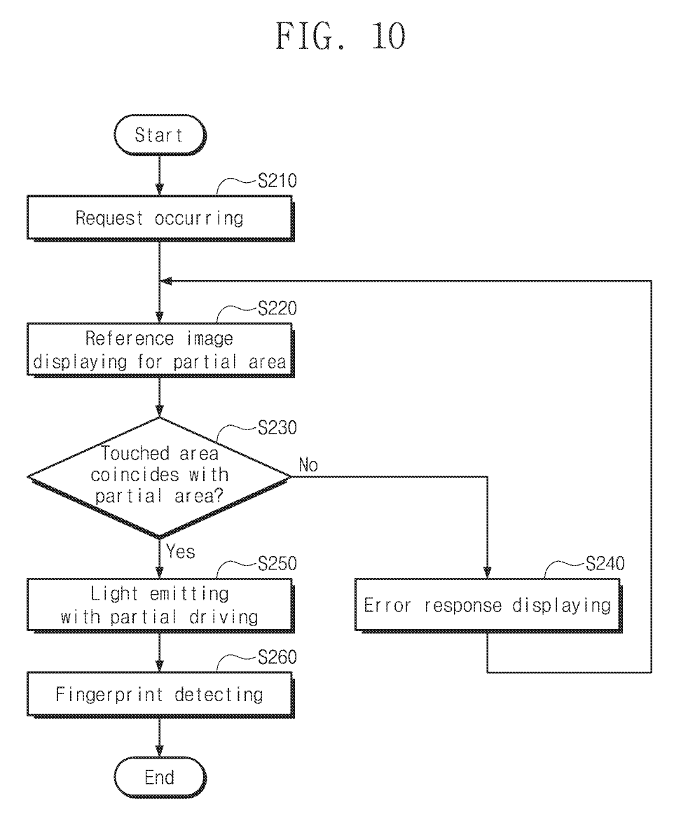

FIG. 9 is a conceptual diagram illustrating an example process of performing a function of fingerprint detection according to the example operation of FIG. 6. To facilitate better understanding, FIG. 9 will be referenced together with FIGS. 1 and 2.

In step 2a, a request may occur (refer to operation S110 of FIG. 6). For example, the request may occur in response to contact or proximity of the object 10 on or to any area on the panel 1005. For example, the request may occur while the display panel 1200 is in a stand-by mode (e.g., while the display panel 1200 displays the reduced or the minimal amount of information such as a current time).

For example, the user may not know the location at which the image sensor 1300 is disposed. Accordingly, in some cases, the user may contact or approach an area other than the partial area PA through the object 10. The electronic device 1000 may determine that a touched area does not coincide with the partial area PA (refer to operation S120 of FIG. 6).

Accordingly, in step 2b, the electronic device 1000 may display a reference image RI by partially driving the display panel 1200 under control of the display driver 1202 (refer to operation S130 of FIG. 6). As described with reference to FIG. 6, the reference image RI may be displayed to inform the user of the location at which the image sensor 1300 is disposed. The reference image RI may be displayed on some or all portions of the partial area PA.

FIG. 9 illustrates the reference image RI of a circle shape, but the present disclosure is not limited thereto. Various attributes, such as a shape, a size, a color, and/or the like, of the reference image RI may be variously modified or changed to inform the user of the location at which the image sensor 1300 is disposed.

Afterwards, in step 2c, the user may contact or approach, through the object 10, the partial area PA in which the reference image RI is displayed. The electronic device 1000 may determine that a touched area coincides with the partial area PA (refer to operation S140 of FIG. 6). Accordingly, in step 2d, the electronic device 1000 may emit light by partially driving the display panel 1200 under control of the display driver 1202 (refer to operation S160 of FIG. 6). The electronic device 1000 may generate an image signal associated with the object 10 which is on the partial area PA, based on the emitted light.

In step 2e, the electronic device 1000 may detect a fingerprint based on the image signal (refer to operation S170 of FIG. 6). The electronic device 1000 may determine whether the detected fingerprint is a fingerprint of an authenticated user.

The reference image RI may be provided in association with a function of fingerprint detection. For example, since the function of fingerprint detection is associated with an issue of user authentication and security, the function of fingerprint detection may be processed with the highest priority. In some example embodiments, the electronic device 1000 may suitably drive the display panel 1200 under control of the display driver 1202, such that an interface (e.g., the contact or proximity of the object 10) associated with the reference image RI is processed prior to an interface (e.g., a time setting) associated with the stand-by mode.

In some cases, unlike step 2c, the user may contact or approach an area other than the partial area PA again, even though the reference image RI is displayed. In this case, the electronic device 1000 may display an error response to inform the user that a touched area does not coincide with the partial area PA (refer to operation S150 of FIG. 6).

FIG. 10 is a flowchart describing an example operation of the electronic device of FIG. 1. To facilitate better understanding, FIG. 10 will be referenced together with FIGS. 1 and 2.

In operation S210, a request may occur. The request may be associated with a signal or action which directs detecting of a fingerprint. For example, the request may occur while the electronic device 1000 is in an idle state or while the display panel 1200 is not driven. For example, the request may occur while the display panel 1200 is in a stand-by mode or a normal mode.

For example, the request of operation S210 may occur when the object 10 contacts or approaches the touch sensor panel 1100 or the display panel 1200 or when the object 10 acts specific motion or gesture in the vicinity of the electronic device 1000. Alternatively, the request of operation S210 may occur when the electronic device 1000 moves in a specific manner. In this case, in operation S220, the display panel 1200 may display a reference image on the partial area PA′. The reference image may be displayed to inform the user of the location at which the image sensor 1300 is disposed.

Afterwards, in response to displaying the reference image, the object 10 may contact or approach any area on the touch sensor panel 1100 or the display panel 1200. In operation S230, the touch processor 1102 may determine whether the touched area coincides with the partial area PA in which the reference image is displayed.

In some cases, even though the reference image is displayed, the object 10 may contact or approach an area other than the partial area PA, and thus, the touched area may not coincide with the partial area PA. When it is determined in operation S230 that the touched area does not coincide with the partial area PA, operation S240 may be performed. In operation S240, the display panel 1200 may display an error response. The error response may be displayed to inform the user that the touched area does not coincide with the partial area PA. In some cases, to inform the user of the location at which the image sensor 1300 is disposed, the display panel 1200 may again display the reference image in operation S220.

On the other hand, when it is determined in operation S230 that the touched area coincides with the partial area PA, operation S250 may be performed. In operation S250, the display panel 1200 may emit light through the pixels which spatially correspond to the location at which the image sensor 1300 is disposed. Accordingly, when the object 10 contacts or approaches the partial area PA′ in which the reference image is displayed, the light may be emitted.

In operation S260, the image sensor 1300 may output an image signal associated with the object 10 which is on the partial area PA, based on the light emitted in operation S250. The image signal may include information associated with the object 10 (e.g., information associated with a shape of a fingerprint). Accordingly, the electronic device 1000 may detect a fingerprint of the object 10 based on the image signal. For example, the main processor 1900 may detect whether the fingerprint indicated by the image signal is a fingerprint of an authenticated user. Accordingly, the electronic device 1000 may provide a service only to the authenticated user.

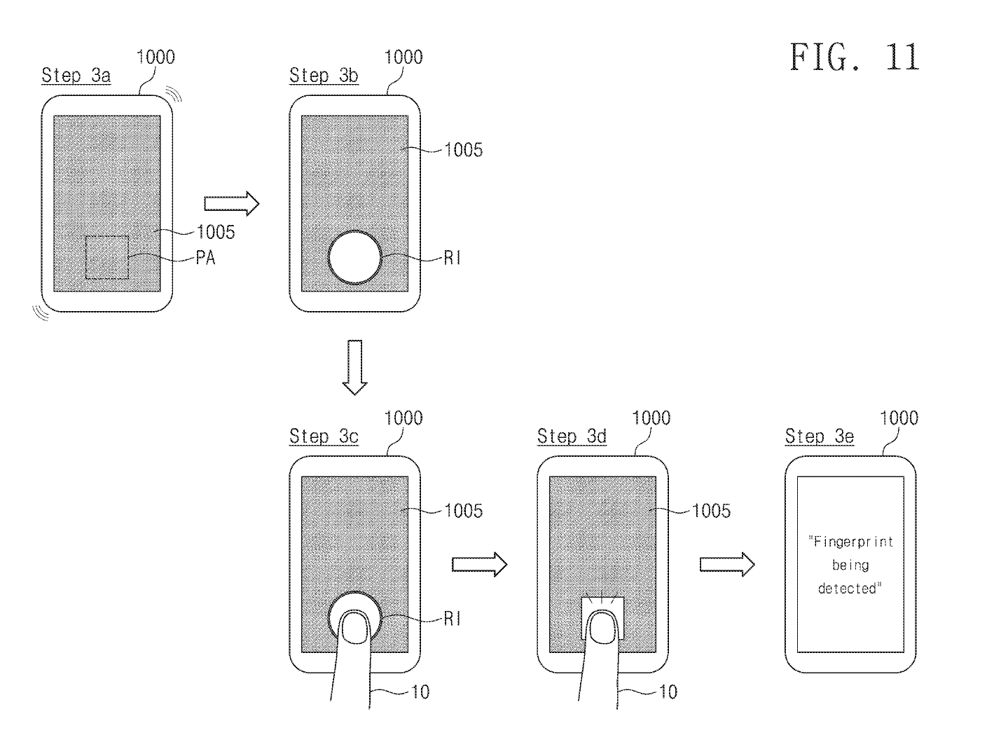

FIG. 11 is a conceptual diagram illustrating an example process of performing a function of fingerprint detection according to the example operation of FIG. 10. To facilitate better understanding, FIG. 11 will be referenced together with FIGS. 1 and 2.

In step 3a, a request may occur (refer to operation S210 of FIG. 10). For example, the request may occur in response to specific motion (e.g., shaking) of the electronic device 1000, but the present disclosure is not limited thereto. For example, the request may occur while the display panel 1200 is not driven.

In step 3b, the electronic device 1000 may display the reference image RI by partially driving the display panel 1200 under control of the display driver 1202 in response to the request (refer to operation S220 of FIG. 10). The reference image RI may be displayed to inform the user of the location at which the image sensor 1300 is disposed. The reference image RI may be displayed on some or all portions of the partial area PA on the panel 1005.

In some example embodiments, the display driver 1202 may be deactivated while not driving the display panel 1200. For example, when the display driver 1202 is deactivated, supplying power to the display driver 1202 may be interrupted or the display driver 1202 may be in an idle state without an active operation.

The display driver 1202 may be activated in response to the request. For example, when the request occurs, the touch processor 1102 and/or the main processor 1900 may provide a “wake-up” signal to the display driver 1202 to activate the display driver 1202. After being activated in response to the request, the display driver 1202 may drive the display panel 1200 such that the reference image RI is displayed.

Afterwards, in step 3c, the user may contact or approach, through the object 10, the partial area PA in which the reference image RI is displayed. The electronic device 1000 may determine that a touched area coincides with the partial area PA (refer to operation S230 of FIG. 10). Accordingly, in step 3d, the electronic device 1000 may emit light by partially driving the display panel 1200 under control of the display driver 1202 (refer to operation S250 of FIG. 10). The electronic device 1000 may generate an image signal associated with the object 10 which is on the partial area PA, based on the emitted light.

In step 3e, the electronic device 1000 may detect a fingerprint based on the image signal (refer to operation S260 of FIG. 10). The electronic device 1000 may determine whether the detected fingerprint is a fingerprint of an authenticated user.

In some cases, unlike step 3c, the user may contact or approach an area other than the partial area PA even though the reference image RI is displayed. In this case, the electronic device 1000 may display an error response to inform the user that a touched area does not coincide with the partial area PA (refer to operation S240 of FIG. 10).

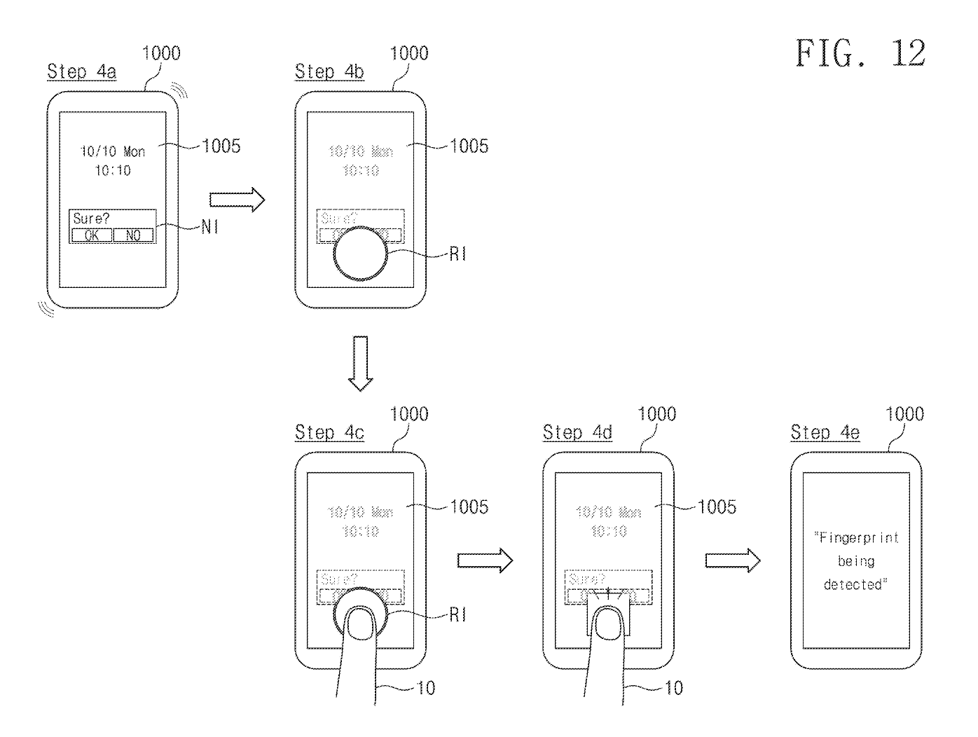

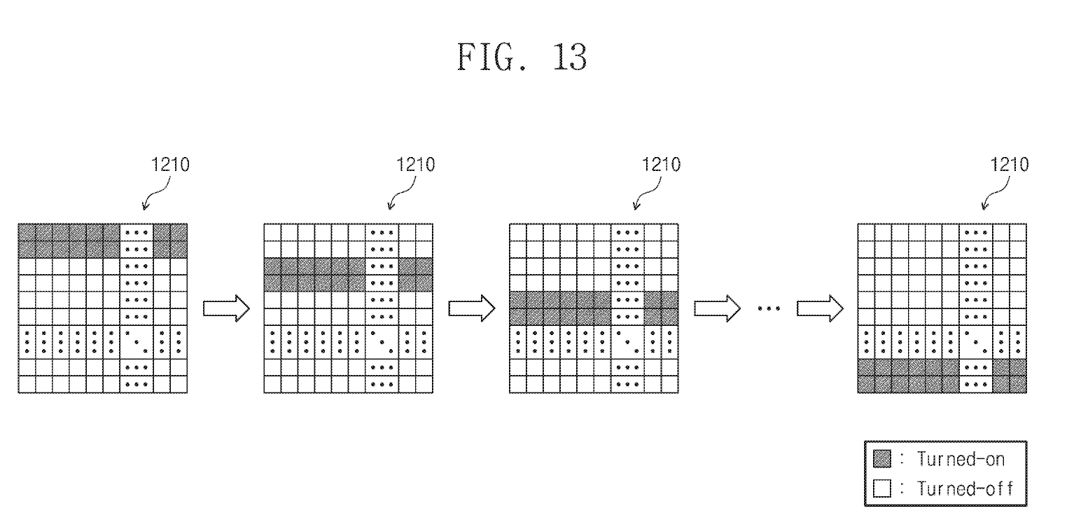

FIG. 12 is a conceptual diagram illustrating an example process of performing a function of fingerprint detection according to the example operation of FIG. 10. To facilitate better understanding, FIG. 12 will be referenced together with FIGS. 1 and 2.

In step 4a, a request may occur (refer to operation S210 of FIG. 10). For example, the request may occur in response to specific motion (e.g., shaking) of the electronic device 1000, but the present disclosure is not limited thereto. For example, the request may occur while the display panel 1200 is in a normal mode (e.g., while the display panel 1200 displays a variety of information such as a user interface NI).

In step 4b, the electronic device 1000 may display the reference image RI by partially driving the display panel 1200 under control of the display driver 1202 in response to the request (refer to operation S220 of FIG. 10). The reference image RI may be displayed to inform the user of the location at which the image sensor 1300 is disposed. The reference image RI may be displayed on some or all portions of the partial area PA on the panel 1005.

In some example embodiments, the electronic device 1000 may suitably drive the display panel 1200 under control of the display driver 1202, such that an interface (e.g., the contact or proximity of the object 10) associated with the reference image RI is processed prior to an interface (e.g., the user interface NI) associated with the normal mode.

Afterwards, in step 4c, the user may contact or approach, through the object 10, the partial area PA in which the reference image RI is displayed. The electronic device 1000 may determine that a touched area coincides with the partial area PA (refer to operation S230 of FIG. 10). Accordingly, in step 4d, the electronic device 1000 may emit light by partially driving the display panel 1200 under control of the display driver 1202 (refer to operation S250 of FIG. 10). The electronic device 1000 may generate an image signal associated with the object 10 which is on the partial area PA, based on the emitted light.

In step 4e, the electronic device 1000 may detect a fingerprint based on the image signal (refer to operation S260 of FIG. 10). The electronic device 1000 may determine whether the detected fingerprint is a fingerprint of an authenticated user.

In some cases, unlike step 4c, the user may contact or approach an area other than the partial area PA even though the reference image RI is displayed. In this case, the electronic device 1000 may display an error response to inform the user that a touched area does not coincide with the partial area PA (refer to operation S240 of FIG. 10).

Various example operations and scenarios for optics-based fingerprint detection of the electronic device 1000 have been described with reference to FIGS. 6 to 12. However, FIGS. 6 to 12 are provided to illustrate some of many possible example embodiments, and are not intended to limit the present disclosure. The example embodiments may be variously modified or changed, for optics-based fingerprint detection, to be different from those described with reference to FIGS. 6 to 12. According to the example embodiments, a configuration and an operation for performing a function of fingerprint detection may be simplified.

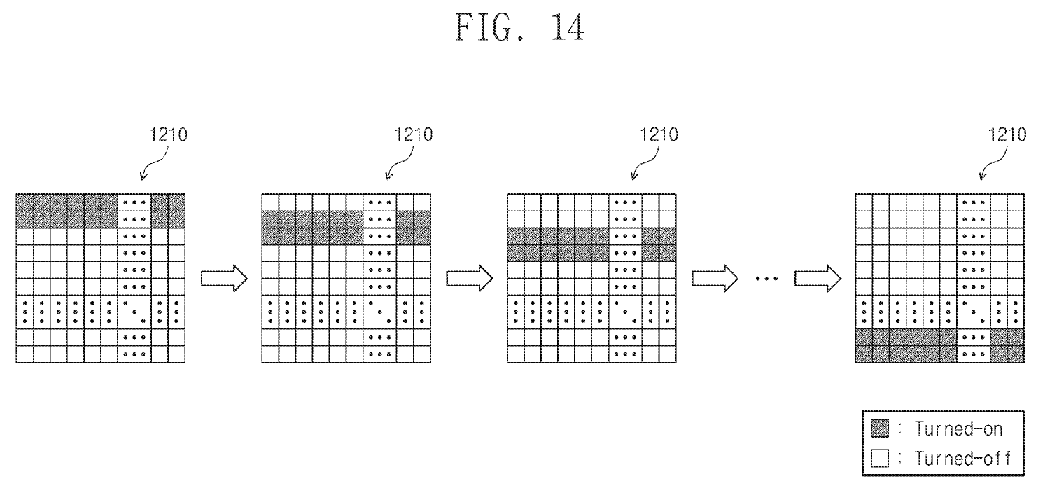

FIGS. 13 to 15 are conceptual diagrams illustrating example methods of driving pixels included in the display panel of the electronic device of FIG. 1. To facilitate better understanding, FIGS. 13 to 15 will be referenced together with FIGS. 1 and 2.

As described above, the display panel 1200 may emit light through the pixels which spatially correspond to the location at which the image sensor 1300 is disposed. To this end, the display driver 1202 may partially drive the display panel 1200 for pixels of the display panel 1200 which are selected to emit light.

To facilitate better understanding, it will be assumed that the pixels 1210 (of FIG. 5) which correspond to the partial area PA′ are selected to emit light. However, the present disclosure is not limited to this assumption. As described above, pixels which are selected to emit light may be variously changed or modified to be sufficient and suitable to obtain an image signal.

In some example embodiments, the pixels 1210 may be driven to emit light simultaneously. Alternatively, in some example embodiments, the pixels 1210 may be driven to emit light based on a reference emission pattern. A pixel which is driven to emit light may be turned on, and a pixel which is not driven may be turned off.

For example, referring to FIG. 13, the pixels 1210 may selectively emit light or may not emit light in unit of a row or a column. A location of a column or a row of pixels emitting light may be sequentially shifted along a specific direction (in some cases, may be randomly shifted regardless of a specific direction). Such a reference emission pattern may look as if a fingerprint of the object 10 is swept or scanned.

For example, referring to FIG. 14, similarly to the example of FIG. 13, the pixels 1210 may selectively emit light or may not emit light in unit of a row or a column. However, a location of a column or a row of pixels emitting light in a previous step may overlap with a location of a column or a row of pixels emitting light in a next step.

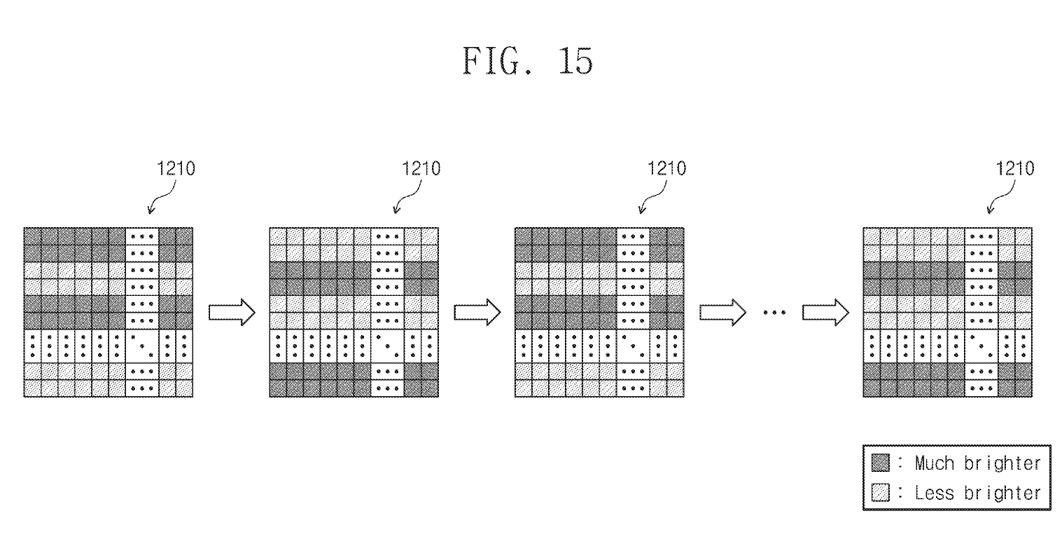

For example, referring to FIG. 15, the pixels 1210 may selectively emit brighter light or less bright light in unit of a row or a column. A location of a column or a row of pixels emitting brighter light and a location of a column or a row of pixels emitting less bright light may be alternately changed.

FIGS. 13 to 15 are provided to illustrate some of many possible reference emission patterns, and are not intended to limit the present disclosure. For example, with regard to the pixels 1210, a location of a pixel emitting light, brightness of light emitted from a pixel, and/or the like, may be changed or modified to be different from those illustrated in FIGS. 13 to 15. For example, the number of columns or rows of pixels emitting light may be changed or modified. For example, pixels emitting light may form different unit other than a column or a row.

The reference emission pattern may be variously changed or modified, to reduce or prevent noise such as interference of light and to suitably detect a fingerprint of the object 10. The display driver 1202 may modulate at least one of various attributes such as brightness of light emitted from pixels, a frequency for driving pixels, locations of pixels emitting light, and/or the like. Accordingly, the display driver 1202 may provide a reference emission pattern which is suitable to detect a fingerprint.

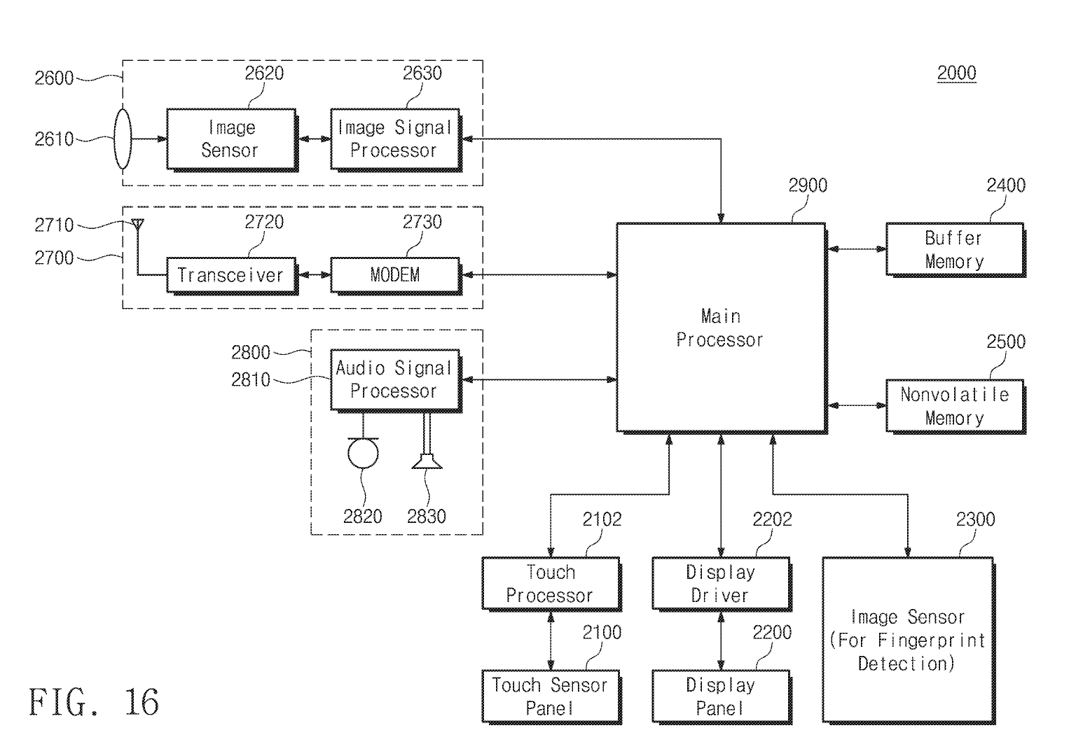

FIG. 16 is a block diagram illustrating an example implementation of an electronic device which performs a function of fingerprint detection according to some example embodiments.

An electronic device 2000 may include a touch sensor panel 2100, a touch processor 2102, a display panel 2200, a display driver 2202, an image sensor 2300 for fingerprint detection, a buffer memory 2400, a nonvolatile memory 2500, an image processor 2600, a communication block 2700, an audio processor 2800, and a main processor 2900. For example, the electronic device 2000 may be one of various electronic devices such as a mobile communication terminal, a personal digital assistant (PDA), a portable media player (PMP), a digital camera, a smart phone, a tablet computer, a laptop computer, a wearable device, and/or the like.

The touch sensor panel 2100, the touch processor 2102, the display panel 2200, the display driver 2202, the image sensor 2300, and the main processor 2900 may respectively correspond to the touch sensor panel 1100, the touch processor 1102, the display panel 1200, the display driver 1202, the image sensor 1300, and the main processor 1900 described with reference to FIGS. 1 to 15.

The image sensor 2300 may be disposed under the touch sensor panel 2100 and/or the display panel 2200 to spatially correspond to a specific area on the touch sensor panel 2100 and/or the display panel 2200. The electronic device 2000 may provide a function of optics-based fingerprint detection by means of the image sensor 2300.

The image sensor 2300 may share an area on the electronic device 2000 with the touch sensor panel 2100 and/or the display panel 2200. The image sensor 2300 may not require an additional area on the electronic device 2000. Accordingly, it may be possible to reduce the size of the electronic device 2000, or a spare area may be used for other purpose(s). In addition, a configuration and an operation for performing a function of fingerprint detection may be simplified.

The buffer memory 2400 may store data used in an operation of the electronic device 2000. For example, the buffer memory 2400 may temporarily store data processed or to be processed by the main processor 2900. For example, the buffer memory 2400 may include a volatile memory such as a static random access memory (SRAM), a dynamic RAM (DRAM), or a synchronous DRAM (SDRAM), and/or a nonvolatile memory such as a phase-change RAM (PRAM), a magneto-resistive RAM (MRAM), a resistive RAM (ReRAM), or a ferroelectric RAM (FRAM).

The nonvolatile memory 2500 may store data regardless of power being supplied. For example, the nonvolatile memory 2500 may include at least one of various nonvolatile memories such as a flash memory, a PRAM, an MRAM, an ReRAM, and an FRAM. For example, the nonvolatile memory 2500 may include an embedded memory of the electronic device 2000 and/or a removable memory.

The image processor 2600 may receive light through a lens 2610. An image sensor 2620 and an image signal processor 2630 included in the image processor 2600 may generate image information associated with an external object, based on the received light.

The communication block 2700 may exchange signals with an external device/system through an antenna 2710. A transceiver 2720 and a modulator/demodulator (MODEM) of the communication block 2700 may process the signals exchanged with the external device/system, based on at least one of various wireless communication protocols such as long term evolution (LTE), worldwide interoperability for microwave access (WIMAX), global system for mobile communication (GSM), code division multiple access (CDMA), Bluetooth, near field communication (NFC), wireless fidelity (Wi-Fi), and radio frequency identification (RFID).

The audio processor 2800 may process an audio signal by an audio signal processor 2810. The audio processor 2800 may receive an audio input through a microphone 2820, or may provide an audio output through a speaker 2830.

The main processor 2900 may control overall operations of the electronic device 2000. The main processor 2900 may control/manage operations of components of the electronic device 2000. The main processor 2900 may process various operations to operate the electronic device 2000. Configurations and operations of the main processor 2900 may include configurations and operations of the main processor 1900 described with reference to FIGS. 1 to 15.

While the present disclosure has been described with reference to some example embodiments, it will be apparent to those skilled in the art that various changes and modifications may be made without departing from the spirit and scope of the present disclosure. Therefore, it should be understood that the above example embodiments are not limiting, but illustrative.

What is claimed is:

1. An electronic device comprising:
a display panel including a plurality of pixels; and
an image sensor disposed under a surface of the display panel to spatially correspond to a location of a partial area on the display panel,
wherein, in response to a touch event while the display panel is not driven or is in a stand-by mode, the display panel is configured to emit light having brightness equal to or higher than a reference brightness through pixels spatially corresponding to a location at which the image sensor is disposed, and
wherein the image sensor is configured to output an image signal associated with an object on the partial area, based on the emitted light.

2. The electronic device of claim 1, wherein
the display panel includes a first surface on which an image is displayed and a second surface opposite to the first surface,
the first surface includes the partial area, and
the image sensor is disposed under the second surface.

3. The electronic device of claim 1, wherein
the image signal includes information associated with a fingerprint.

4. The electronic device of claim 3, further comprising:
a processor configured to compare the fingerprint indicated by the image signal with information stored in a memory.

5. The electronic device of claim 1, wherein
the display panel is configured to emit light when contact of the object is last than a reference time.

6. The electronic device of claim 5, wherein the display panel is an organic light-emitting diode.

7. The electronic device of claim 1, wherein in response to the touch event, the display panel is further configured to display a reference image on at least a portion of the partial area.

8. The electronic device of claim 7, wherein after the reference image is displayed, the display panel is further configured to emit light having brightness equal to or higher than the reference brightness.

9. The electronic device of claim 8, wherein the partial area on which the reference image is displayed indicates an areas where the image sensor is disposed.

10. The electronic device of claim 1, wherein the image sensor is a fingerprint sensor.

11. An electronic device comprising:
a display panel; and
an image sensor disposed under the display panel to spatially correspond to a location of a partial area on the display panel,
wherein the display panel is configured to,
display a reference image on at least a portion of the partial area, in response to a touch event, and
emit light through pixels which spatially correspond to a location at which the image sensor is disposed, and
wherein the image sensor is configured to output an image signal associated with the object, based on the emitted light.

12. The electronic device of claim 11, further comprising:
a touch processor configured to detect contact of an object on the display panel.

13. The electronic device of claim 11, wherein the touch processor is configured to transmit wake up signal to the image sensor when contact of an object is last than a reference time.

14. The electronic device of claim 11, wherein the display panel is further configured to emit light having brightness equal to or higher than the reference brightness after the reference image is displayed.

15. The electronic device of claim 14, wherein brightness of the emitted light is greater than brightness for displaying the reference image.

16. The electronic device of claim 11, wherein the display panel is an organic light-emitting diode.

17. An electronic device comprising:
a display panel;
a display driver configured to drive the display panel; and
an image sensor disposed under the display panel to spatially correspond to a location of a partial area on the display panel,
wherein the display driver is configured to,
partially drive the display panel to display a reference image on at least a portion of the partial area, and
partially drive the display panel, in association with displaying the reference image, to emit light according to a reference emission pattern and through pixels which spatially correspond to a location at which the image sensor is disposed, and
wherein the image sensor is configured to output an image signal, based on light reflected from an object on the partial area in response to the emitted light.

18. The electronic device of claim 17, wherein the display driver is further configured to,
be deactivated while the display driver does not drive the display panel, and
be activated in response to a request which occurs while the display driver does not drive the display panel.

19. The electronic device of claim 18, wherein the display driver is further configured, after being activated in response to the request, to drive the display panel to display the reference image.

20. The electronic device of claim 17, wherein
the display driver is further configured, in response to a request which occurs while the display driver drives the display panel in a stand-by mode or a normal mode, to drive the display panel to display the reference image.
